(19) United States
(12) Patent Application Publication
(10) Pub. No.: US 2011/0011403 A1
(43) Pub. Date: Jan. 20, 2011

(54) Crew Mask Regulator Mechanical Curve Matching Dilution Valve

(75) Inventors: Gary Ray Hannah, Shawnee, KS (US); Richard William Heim, Shawnee, KS (US)

Correspondence Address: RICHARD WILLIAM HEIM, 5130 AMINDA, SHAWNEE, KS, 66226-2682, US

(73) Assignees: Richard William Heim, Shawnee, KS (US); Gary Ray Hannah, Shawnee, KS (US)

(21) Appl. No.: 12/890,672

(22) Filed: Sep. 26, 2010

(51) Int. Cl. A62B 7/00

(52) U.S. Cl. 128/204.29; 128/205.11

(57) ABSTRACT

A demand regulator with air dilution regulates the pressure and flow of a respiratory gas with an outlet leading to a respiratory mask. A dilution valve controlled by a Bourdon tube varies the ratio of atmospheric air to oxygen in a crew mask based on ambient pressure. The Bourdon tube in the dilution valve assembly flexes in response to changes in atmospheric pressure causing the dilution valve to gradually open or close. As altitude increases the dilution valve gradually closes causing more oxygen to be provided to the facemask. The amount of added oxygen for a given atmospheric pressure can be accurately controlled at all altitudes due to the greater adjustment available in the device for calibration and operation compared to the current art. This greater operational capability eliminates the excess use of oxygen at low to intermediate altitudes as is common problem with the current art.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field of Invention

The present invention relates to demand regulators with dilution by ambient air for supplying breathing gas to the crew of aircraft or parachutists who require breathing gas with added oxygen at a flow rate that is a function of altitude. The minimum rate at which oxygen must be supplied is set by the Federal Aviation Regulations (FAR).

2. Prior Art

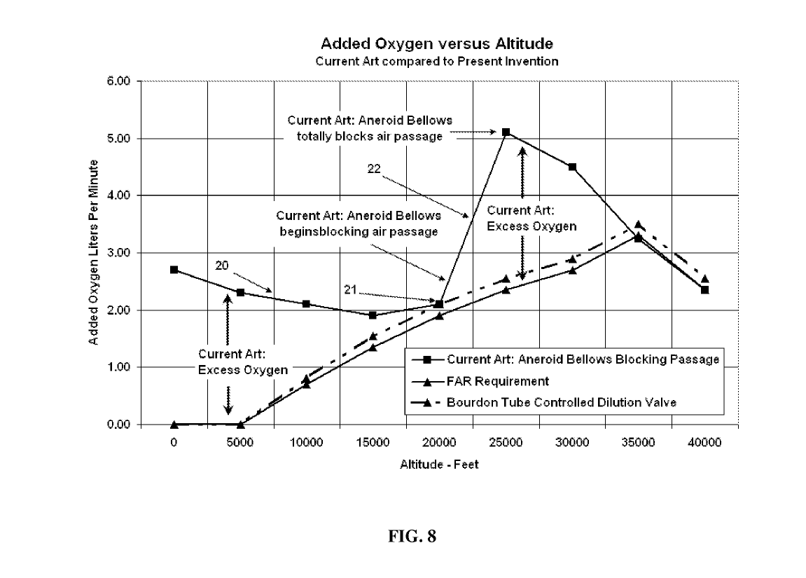

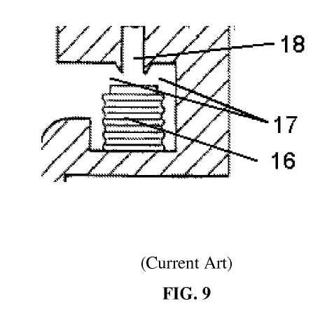

Aircraft crew mask oxygen regulators with dilution using ambient air have been in use for half a century. The purpose of diluting oxygen with ambient air has always been to conserve oxygen when at lower altitudes where 100% oxygen is not needed. As stated in March 1946 by Meidenbauer Jr. in U.S. Pat. No. 2,396,716 “When the aviator is on ground level he requires no extra oxygen in addition to that contained in the ordinary atmosphere and when flying at relatively low altitudes the requirement for extra oxygen is still comparatively small. When, however, flying in the higher critical altitudes the breathing mixture must contain a much larger percentage of oxygen to insure the safety of the aviator. It has been found that air and oxygen mixing devices, as heretofore constructed, supplied a mixture which is too rich for low altitudes when the device was adjusted very close to the critical high altitudes where a man must have from 98% to 100% . . . ” Sixty years later, attempts to solve this problem continue. The current art continues to try to solve the problem of varying dilution with altitude using the same basic design of fifty years ago but in a very small package. The current art still employs the use of a cylinder which expands as ambient pressure decreases and altitude increases. This expanding cylinder closes a valve or passage thereby restricting the amount of ambient air being mixed with oxygen. The term for this component has varied over the last half century, such as “aneroid bellows” or “altimetric capsule”, but the concept is the same. In February 1943, U.S. Pat. No. 2,310,189 refers to an “aneroid-operated valve” and an “aneroid bellows”. Meidenbauer solved the problem as noted above in U.S. Pat. No. 2,396,716 dated Mar. 19, 1946 using an “aneroid”, again a cylinder that expands with altitude. In May 1947 U.S. Pat. No. 2,420,375 used an “aneroid unit” to provide “a very economical use of the available gas supply”. Two decades later in May 1970 Hennemann in U.S. Pat. No. 3,509,895 still used a cylindrical “aneroid” to expand and move a “valve plate” thus “creating a passage to ambient pressure” thereby regulating dilution of oxygen with ambient air. As recently as Sep. 14, 2004 Martinez in U.S. Pat. No. 6,789,539 used an “altimeter capsule”, which again is a cylinder which expands as ambient pressure drops. In this application, a “dilution air flow passage is defined between an altimeter capsule of length that increases as ambient pressure decreases and the end edge of an annular piston”. Again in September 2004 Martinez uses an “altimetric capsule” in U.S. Pat. No. 6,796,306 which “cuts off or authorizes the entry of air via the dilution air inlet as a function of altitude. At high altitude, the altimetric capsule cuts the entry of dilution air so that the mask is supplied only with the additional gas originating with the flow limiter”. All of this current art is using the basic concept of what Deming did in U.S. Pat. No. 2,310,189 back in February 1943. The difference between 1943 and now is that the current art integrates the diluter-demand regulator into the crew mask. In U.S. Pat. No. 2,310,189 Deming had the advantage of a very large device which was separate from the crew mask. Such a large device allowed the “aneroid bellows” to be much larger than the current art. This provided Deming with a large amount of change in the aneroid cylinder length as ambient pressure decreased which in turn allowed the dilution valve to have large movements as pressure dropped. Calibrating the dilution valve for various altitudes was easily accomplished even for low to intermediate altitudes since there was a large amount of movement and therefore much resolution available in the calibrating adjustments. The current art must be able to calibrate the “altimeter capsule” or “aneroid” over a very small range of movement since this old design concept is being incorporated into very small dilution-demand regulators. This is the reason this problem continues to persist over a half century: Very small dilution regulators still attempt to use a cylindrical “aneroid” which expands linearly in length to decreasing ambient pressure. The current art is now realizing that this old cylindrical aneroid concept does not work well in small regulators and are therefore either trying to solve it using very complex electronic regulators or they are simply giving up on the ability to accurately dilute oxygen at low altitudes. This is apparent is U.S. patent application US 2007/0084469 dated Apr. 19, 2007 where it is stated “It is very difficult and impractical to design a conventional regulator so that the required quantity of oxygen is delivered at 10,000 ft, but no oxygen is delivered at slightly lower pressure altitudes where the ambient pressure is only slightly higher, such as approximately 5,000 to 8,000 ft cabin pressure altitude”. This problem is illustrated in FIG. 8 by 20. It is very difficult because they are trying to use concepts originating in 1943 in large devices and applying them in very small devices. The current art uses cylindrical “aneroids” of such a small size that they only expand approximately 0.030 inches to fully close or block a passage. As they expand the idea is that the expansion is linear with the decrease in ambient pressure, which is true. The problem is the linear expansion does not cause a linear reduction of flow through the passage it is trying to control. Illustrated in FIG. 9, as the flat end of the aneroid cylinder or altimetric capsule 16 begins to expand towards blocking the passage 18, there is very little restriction of flow since the area of the passage 18 being obstructed is much smaller than area 17 around the altimetric capsule 16. Changes in the length of altimetric capsule 16 have no affect until area 17 is smaller than the area of passage 18 which only occurs at higher altitudes. Therefore at low altitudes as the cylinder begins to expand it has very little affect on the amount of added oxygen, shown by 20 in FIG. 8. This inherent flaw of the current art requires the current art to be calibrated such that excess added oxygen is used at lower altitude to ensure the added oxygen is above the minimum required at intermediate altitudes as shown in FIG. 8. Calibrating the current art amounts to making sure 21 of FIG. 8 is above the FAR requirement, regardless of how much excess added oxygen is wasted at other altitudes. Eventually at higher altitudes the current art's altimetric capsule 16 expands enough such that the area 17 around the cylinder is smaller than the passage 18 it is trying to block and the “aneroid” begins affecting the mixing of dilution air and oxygen, as shown by 22 in FIG. 8. Rather than being a linear function, the current art's added oxygen curve more closely resembles a step function as shown in FIG. 8. Martinez in U.S. Pat. No. 6,796,306 attempts to break this step function into pieces using a complex “flow limiter”. The flow limiter switches the supply of gas between several inlet passages having different cross sections. One passage would be an “economy” flow and another would be a “full flow” passage. Again, the current art is trying to force the use of a cylindrical aneroid in a very small device which requires the creation of elaborate complexities in order to obtain any control of flow rates at low to intermediate altitudes. The solution proposed in U.S. patent application US 2007/0084469 is to simply bypass the regulator at lower altitudes with an “auxiliary breathing flow channel apparatus”. This additional complex and costly apparatus added to the already complex demand diluter regulator, still uses an “aneroid capsule” to determine when to bypass the regulator. This concept of bypassing the regulator also dates back to the 1940's. Deming in U.S. Pat. No. 2,378,468 states “as long as the pressure within the mask is above that level, no oxygen will be discharged to the mask”. U.S. patent application US 2007/0084469 also states that “Further it is very difficult and impractical to design a conventional regulator with very low inhalation resistance in a sufficiently compact and light weight package to render it practical to be mounted directly on the user's oxygen mask”. The current art has given up on a simple mechanical solution to this problem and is therefore solving the problem by bypassing the regulator or by using complex electronics. U.S. Pat. No. 4,648,397 and U.S. Pat. No. 7,584,753 both eliminate the use of an expanding cylinder, or “aneroid” to control dilution rates. They have resorted to highly complex electronic devices, software and sensors. Also, electronic regulators must be designed to provide 100% oxygen in the event of a power failure. This causes excess oxygen to be brought onboard the aircraft in preparation for this worse case scenario. It is the contention of this application that complex mechanical or electronic dilution demand regulators are not necessary to solve the problem of accurately diluting oxygen at all altitudes. In fact, such complex solutions only increase cost and reduce reliability. What is needed is a simple, reliable device such as achieved by Deming in U.S. Pat. No. 2,310,189 but such that it is compact and lightweight allowing it to be mounted directly on the face mask. The present invention achieves creating such a compact and lightweight device through the use of a Bourdon tube. The current art has many examples of Bourdon tubes but mainly for sensing and indicating fluid pressure, as in U.S. Pat. No. 4,462,301 dated July 1984. The current art described by Strange in U.S. Pat. No. 2,378,047 dated July 1945 uses a Bourdon tube to regulate the flow of oxygen in a regulator. Strange controls the flow of oxygen via slave and master valves whereas the present invention directly controls the flow of dilution air into the regulator.

### SUMMARY

The present invention provides a simple, low cost, and reliable demand diluter regulator which can be integrated into crew masks and accurately provide aircrews with the required added oxygen at all flight altitudes without providing an excess of oxygen. This allows aircraft to plan for longer flights using onboard oxygen or to bring less oxygen onboard thereby reducing costs.

### DRAWINGS

### Figures

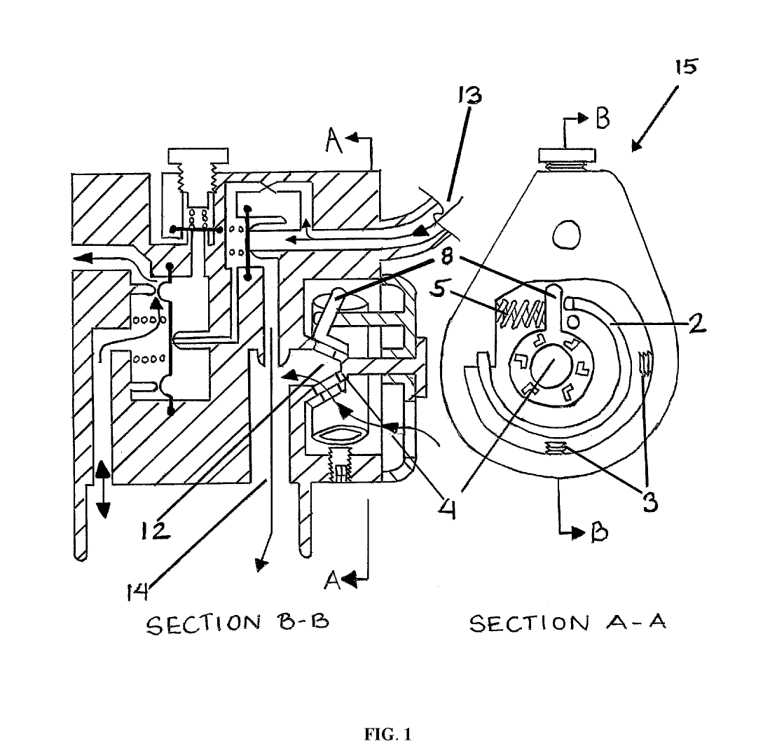

FIG. 1 shows the dilution valve assembly integrated with a regulator.

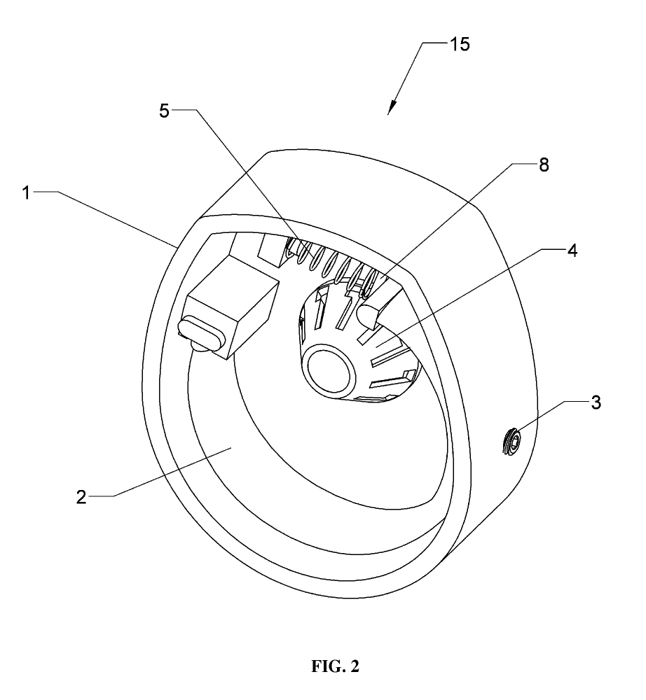

FIG. 2 shows an isometric view of the dilution valve assembly.

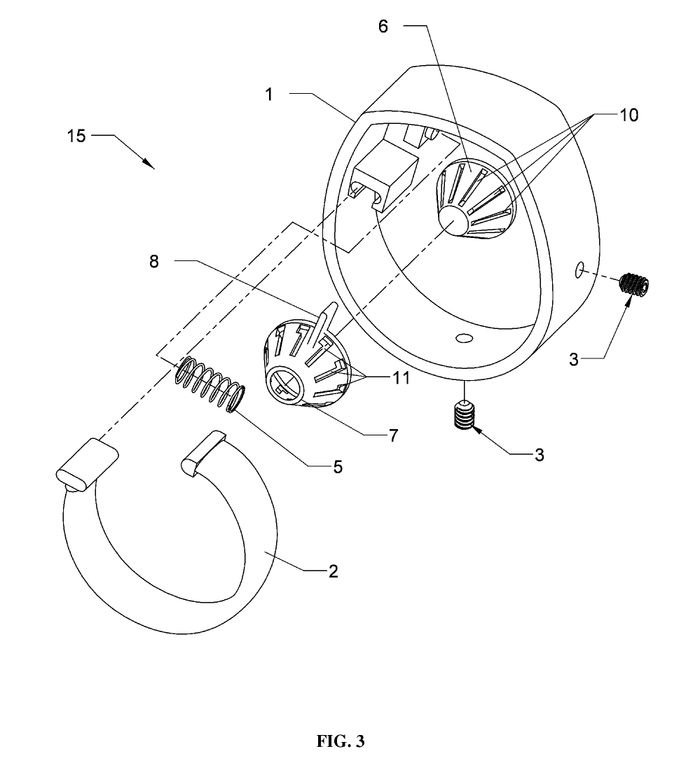

FIG. 3 shows an exploded view of the dilution valve assembly.

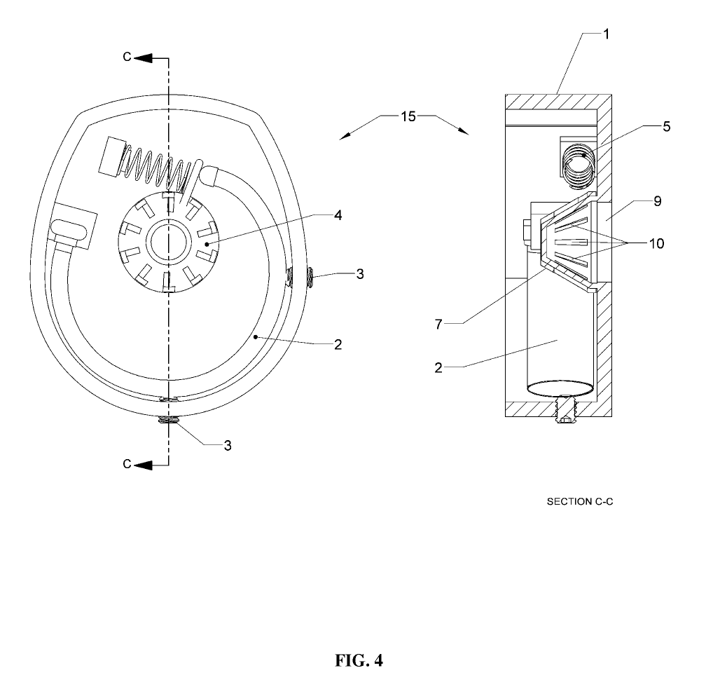

FIG. 4 shows a cross-section of the dilution valve assembly.

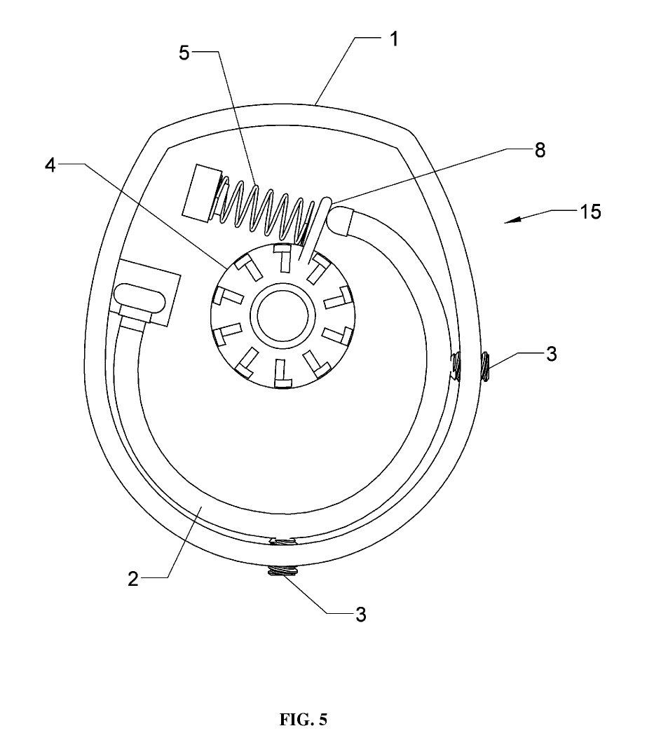

FIG. 5 shows the dilution valve assembly in the closed position.

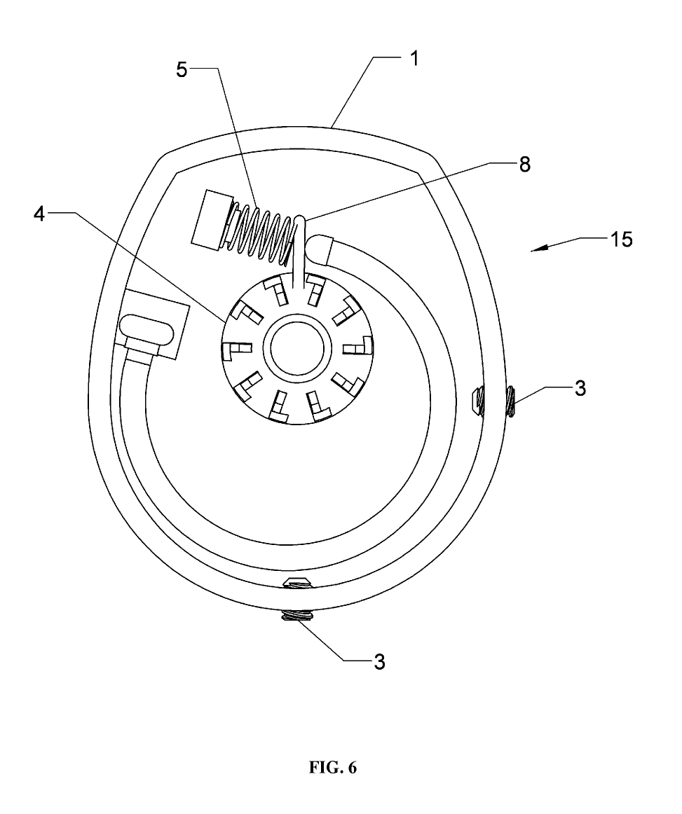

FIG. 6 shows the dilution valve assembly in an open position.

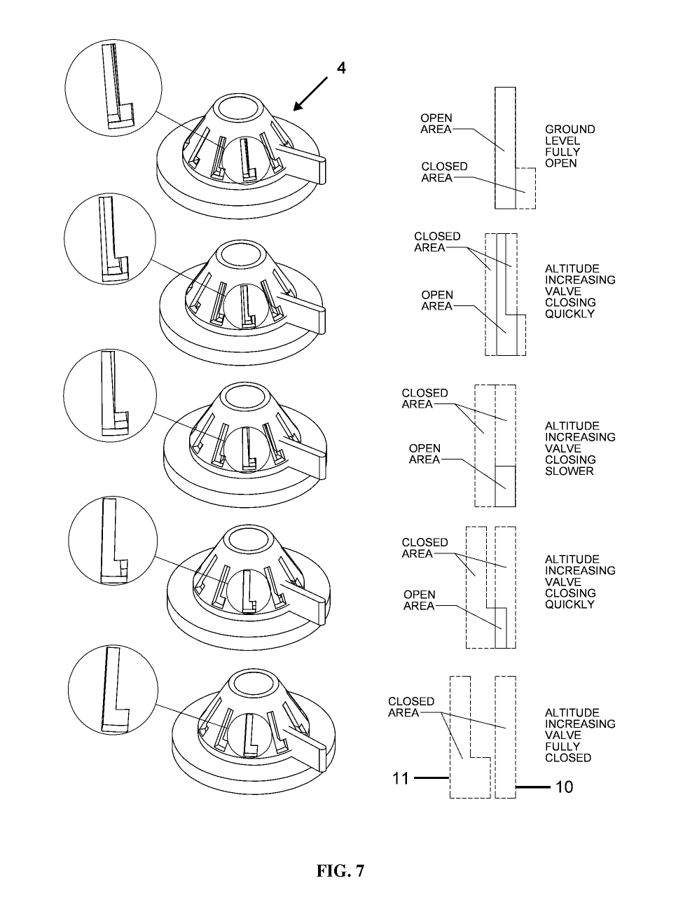

FIG. 7 shows the dilution valve operating at various altitudes.

FIG. 8 is a graph of added oxygen at various altitudes.

FIG. 9 shows the current art's altimetric capsule concept.

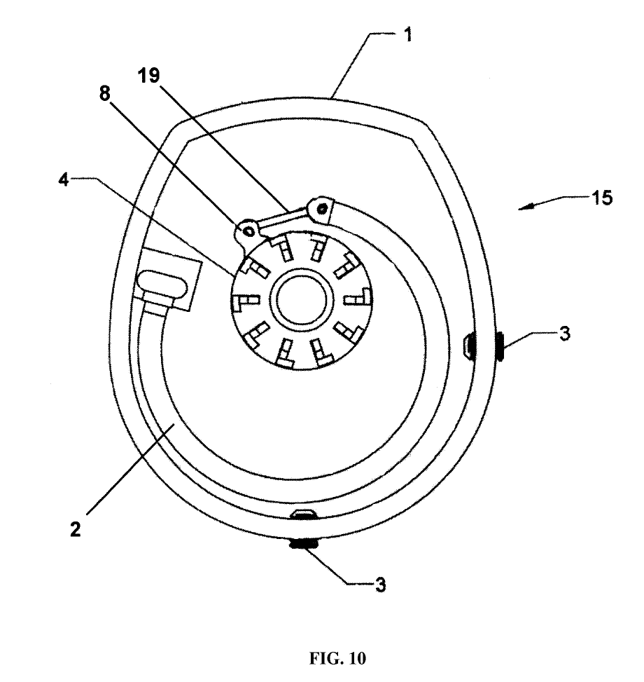

FIG. 10 is an alternative embodiment using a linkage to operate the dilution valve.

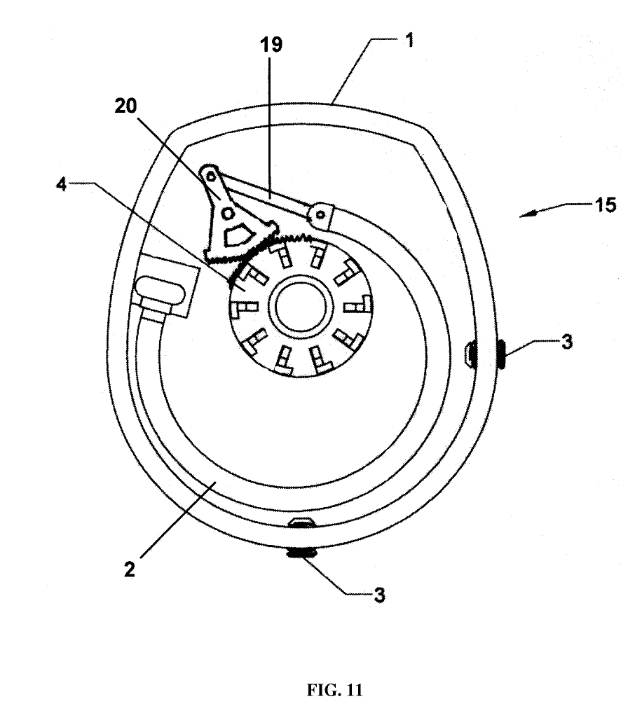

FIG. 11 is an alternative embodiment using a linkage and gear to operate the dilution valve.

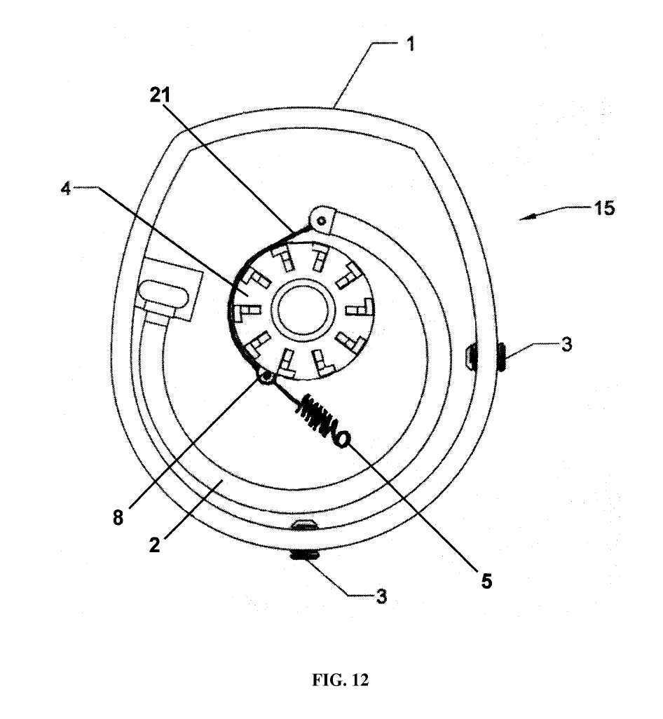

FIG. 12 is an alternative embodiment using a belt and spring to operate the dilution valve.

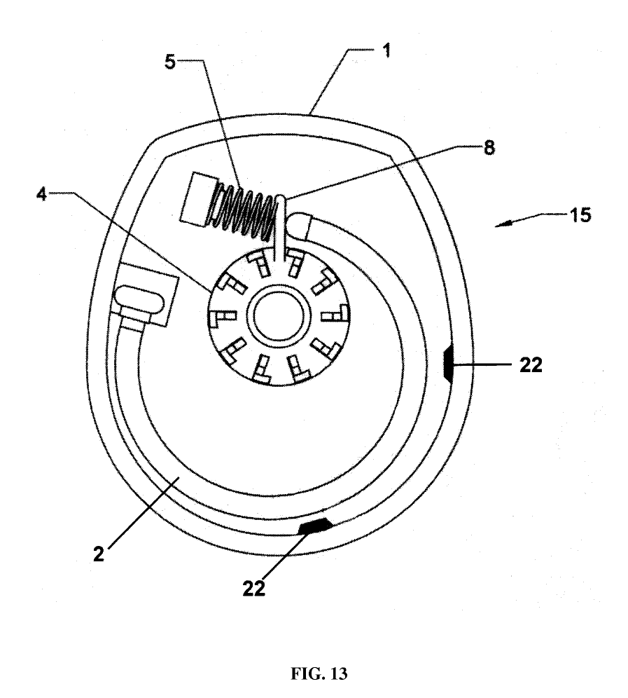

FIG. 13 is an alternative embodiment using shims to restrict Bourdon tube movement.

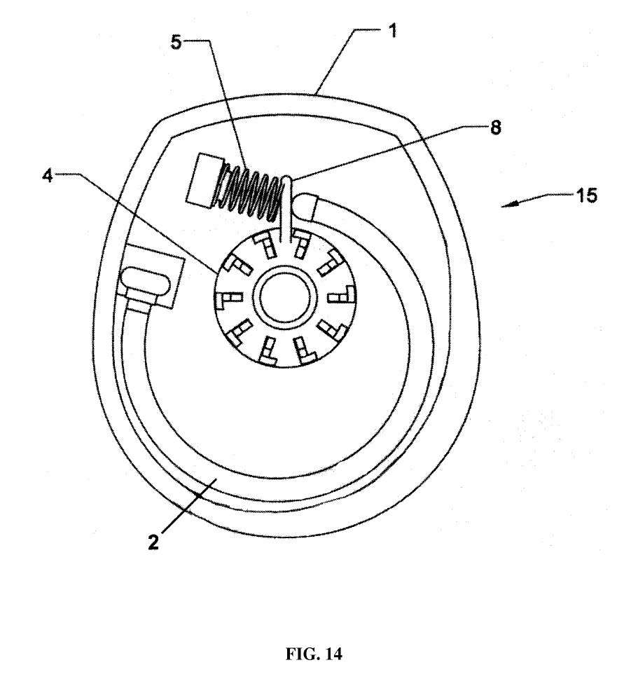

FIG. 14 is an alternative embodiment using housing shape to restrict Bourdon tube movement.

### REFERENCE NUMERALS

1 housing
2 Bourdon tube
3 set screws
4 dilution valve
5 spring
6 valve base
7 valve cap
8 valve arm
9 base outlet
10 base slots
11 cap slots
12 regulator air inlet
13 regulator oxygen inlet
14 regulator outlet
15 dilution valve assembly
16 altimetric capsule
17 area
18 passage
19 linkage
20 gear
21 belt
22 shim

### DETAILED DESCRIPTION

A first embodiment of the present invention is now described. FIG. 1 shows the dilution valve assembly 15 integrated with a regulator. The dilution valve 4 controls the amount of ambient air being diluting oxygen at regulator outlet 14. The dilution valve assembly 15, shown in FIG. 2 and FIG. 3, is comprised of a housing 1, Bourdon tube 2, set screws 3, dilution valve 4, and spring 5. Dilution valve 4 is comprised of valve base 6, valve cap 7, and valve arm 8. As shown in FIG. 3 and FIG. 4, valve base 6 is comprised of base outlet 9 and base slots 10 while valve cap 7 contains cap slots 11. Valve cap 7 fits onto valve base 6 and can rotate on valve base 6 causing the cap slots 11 and base slots 10 to either align and allow flow or misalign and block flow through base outlet 9. Valve arm 8 protrudes from valve cap 7 providing a moment arm to operate dilution valve 4. FIG. 5 and FIG. 6 show how Bourdon tube 2 is positioned in housing 1 such that it can flex as atmospheric pressure varies. Several set screws 3 are installed into housing 1 such that they protrude through housing 1 and can contact Bourdon tube 2 at several locations along its length.

### Operation

The operation of the first embodiment is now described. The dilution valve assembly 15 is installed on atmospheric air inlet 12 of a crew mask regulator shown in FIG. 1. As altitude changes and therefore atmospheric air pressure changes, Bourdon tube 2 flexes thereby operating dilution valve 4 via valve arm 8 such that cap slots 11 and base slots 10 become more aligned or less aligned depending on rotation direction of valve cap 7. As altitude increases and air pressure decreases Bourdon tube 2 flexes away from valve arm 8 allowing spring 5 to rotate valve cap 7 via valve arm 8. Valve cap 7 is rotated such that cap slots 11 become less aligned with base slots 10 thereby reducing the flow of atmospheric air through the dilution valve 4 and into the regulator air inlet 12 as illustrated in FIG. 5. This causes the oxygen supplied to a crew mask, which is not shown, through regulator outlet 14 to be less diluted. FIG. 7 shows dilution valve 4 operating at various altitudes and how base slots 10 and cap slots 11 regulate the flow through dilution valve 4. As altitude decreases and air pressure increases Bourdon tube 2 contracts and pushes against valve arm 8 compressing spring 5. Valve cap 7 is rotated such that cap slots 11 become more aligned with base slots 10 thereby increasing the flow of atmospheric air through dilution valve 4 and into the regulator air inlet 12 illustrated in FIG. 6. This causes the oxygen supplied to the crew mask through the regulator outlet 14 to be more diluted. The amount of added oxygen for a given pressure can be accurately controlled by calibrating the dilution valve 4 using set screws 3, as described below.

### Curve Matching Calibration

Calibration of the first embodiment is now described. Dilution valve 4 can be accurately calibrated to cause a regulator to provide added oxygen to a crew mask per the Federal Aviation Regulations (FAR). To calibrate dilution valve 4 a regulator with the present invention installed is placed in a vacuum chamber. An external oxygen source supplies oxygen to the regulator through regulator oxygen inlet 13. The regulator has regulator air inlet 12 to receive atmospheric air from within the vacuum chamber. Dilution valve 4 is attached to regulator air inlet 12. Regulator outlet 14 supplies a crew mask, which is not shown, with oxygen diluted with ambient air. The gas exiting through regulator outlet 14 comprises a mixture of oxygen and atmospheric air. The added oxygen requirement curve shown in FIG. 8 can be matched very closely by the present invention by adjusting the set screws 3 at various vacuum chamber pressures which represent altitudes shown in FIG. 8. Set screws 3 affect the shape of the added oxygen curve in FIG. 8 by restricting the amount of movement available to Bourdon tube 2 as it flexes and thereby controlling the amount dilution valve 4 is opened or closed. The current art's cylindrical “aneroid” only has travel of 0.030 inches where the present invention's Bourdon tube 2 has travel of 0.30 inches. This greater travel allows ten times the resolution in calibration as compared to the current art's crude calibration capability. Calibration is accomplished by restricting how much Bourdon tube 2 is allowed to flex for a given ambient pressure thereby controlling how much dilution valve 4 closes for a given atmospheric pressure. During calibration the vacuum chamber is set to various pressures corresponding to altitudes show in FIG. 8. At each pressure, set screws 3 are adjusted so that dilution valve 4 is closed an amount whereby the flow rate of added oxygen through oxygen inlet 13 shown in FIG. 1 into the crew mask matches the added oxygen required by the FAR. In this manner the flow rate of added oxygen into the crew mask is matched to the FAR requirement shown in FIG. 8 for each altitude. This capability is a major improvement over the current art. In addition to tailoring the shape of the added oxygen curve using sets screws 3, the shape of the added oxygen curve can also be tailored by the shapes of cap slots 11 and/or valve base slots 10. The shape of the leading and trailing edges of cap slots 11 and valve base slots 10 can be tailored to affect the rate of change of added oxygen as cap slots 11 sweep across base slots 10.

### Alternative Embodiments

The present invention may be embodied in numerous ways. In particular, the mechanical mechanism which operates the dilution valve 4 when Bourdon tube 2 flexes and the mechanical restriction to Bourdon tube 2 flexing can be embodied many ways. The first embodiment of this mechanical mechanism and restriction, described above, is comprised of spring 5 and valve arm 8 and set screws 3. Alternative embodiments are shown if FIG. 10-FIG. 14. These alternative embodiments are described below.

One alternative embodiment to operate dilution valve 4 uses a linkage 19 to attach Bourdon tube 2 to valve arm 8 as shown in FIG. 10.

Another alternative embodiment to operate dilution valve 4 uses a gear train 20 which is attached to Bourdon tube 2 using linkage 19 as shown in FIG. 11.

Another alternative embodiment to operate dilution valve 4 uses a belt 21 which is attached to valve arm 8 and Bourdon tube 2, and a spring 5 which is fixed at one end and with the other end attached to valve arm 8 as shown in FIG. 12. One alternative embodiment to mechanically restrict the movement of Bourdon tube 2 is through the use of shims 22 as shown in FIG. 13.

Another alternative embodiment to mechanically restrict the movement of Bourdon tube 2 is by shaping housing 1 to provide the desired mechanical restriction as shown if FIG. 14.

### Advantages

From the description above, a number of advantages of some embodiments of our present invention become evident:

(a) Eliminates waste of excess added oxygen to crew masks for any flight altitude. Allows aircraft to plan for longer flights using onboard oxygen and/or bring less oxygen onboard, thereby reducing costs.
(b) Ease of calibration during manufacturing. The present invention has ten times the travel available for adjustment, compared to the current art. This provides ten times the resolution for calibration at all altitudes.
(c) Curve-match FAR standards for required added oxygen at various altitudes providing precise control of added oxygen at every altitude, including low to intermediate altitudes.
(d) Lower manufacturing costs. Components are simple to manufacture compared to the current art's use of complex mechanical assemblies and electronics.
(e) Does not require default to 100% oxygen in the event of aircraft power failure as do electronic regulators thereby reducing amount of onboard oxygen to be carried.
(f) Can be used by high altitude parachutists or mountaineers requiring supplemental oxygen. Very accurate dilution of oxygen at low altitudes compared to the current art. This allows fewer pounds of oxygen to be carried since excess oxygen use can be eliminated.

### CONCLUSION, RAMIFICATIONS, AND SCOPE

The reader will see that, according to one embodiment of the invention, we have provided an apparatus which accurately controls the dilution of oxygen in a regulator for a crew mask over a wide range of altitudes. The apparatus can be accurately calibrated to match the required oxygen for aircrews at various altitudes thereby avoiding carrying excess oxygen tanks onboard aircraft or allowing for longer flights on oxygen. Additionally the present invention is much simpler than the current art and less expensive to manufacture. While the above description contains many specificities, these should not be construed as limitations on the scope of any embodiment, but as exemplifications of the presently preferred embodiments thereof. Many other variations are possible within the teachings of the various embodiments. Thus the scope of the invention should be determined by the appended claims and their legal equivalents, and not by the examples given.

We claim:

1. An apparatus using a Bourdon tube to vary the dilution of oxygen in a regulator in response to ambient pressure.

2. The apparatus of claim 1 where said apparatus is for use on aircraft crew masks.

3. An apparatus using a Bourdon tube to vary the dilution of oxygen in a regulator in response to ambient pressure wherein said apparatus comprises:
(a) a housing,
(b) a dilution valve,
(c) a Bourdon tube,
(d) a mechanical mechanism to transfer motion of said Bourdon tube to operate said dilution valve, and
(e) said Bourdon tube being positioned in said housing with one end of said Bourdon being fixed and other end of said Bourdon tube being attached to said valve via said mechanical mechanism,
whereby said dilution valve is operated when said Bourdon tube flexes due to changes in ambient pressure.

4. The apparatus in claim 3 where flexing of said Bourdon tube is restricted from movement by means at one or more positions along the length of said Bourdon tube thereby restricting the proportion to which said dilution valve is operated for a given ambient pressure,
whereby changes in ambient pressure causes said Bourdon tube to flex thereby operating said dilution valve and varying the flow of a gas through said dilution valve a predetermined amount for a given ambient pressure via said restriction by means of Bourdon tube movement.

5. The apparatus in claim 4 where said apparatus is for use with aircraft crew masks and said means to restrict flexing of said Bourdon tube are set screws, shims, or the shape of said housing, whereby the correct amount of added oxygen is supplied to aircrews over a wide range of ambient pressures.

6. The apparatus in claim 3 wherein said mechanical mechanism to transfer motion of said Bourdon tube to operate said dilution valve comprises:
(a) a valve arm that operates said dilution valve,
(b) a linkage attaching said Bourdon tube to said valve arm, and
(c) said Bourdon tube being positioned in said housing with one end of said Bourdon tube being fixed and other end of said Bourdon tube being attached to said valve arm with said linkage, whereby said dilution valve is operated when said Bourdon tube flexes due to changes in ambient pressure.

7. The apparatus in claim 6 where flexing of said Bourdon tube is restricted from movement by means at one or more positions along the length of said Bourdon tube thereby restricting the proportion to which said dilution valve is operated for a given ambient pressure,
whereby changes in ambient pressure causes said Bourdon tube to flex thereby operating said dilution valve and varying the flow of a gas through said dilution valve a predetermined amount for a given ambient pressure via said restriction by means of Bourdon tube movement.

8. The apparatus in claim 7 where said apparatus is for use with aircraft crew masks and said means to restrict flexing of said Bourdon tube are set screws, shims, or the shape of said housing, whereby the correct amount of added oxygen is supplied to aircrews over a wide range of ambient pressures.

9. The apparatus in claim 3 wherein said mechanical mechanism to transfer motion of said Bourdon tube to operate said dilution valve comprises:
(a) a valve arm that operates said dilution valve,
(b) a spring which presses said valve arm against one end of said Bourdon tube, and
(c) said Bourdon tube being positioned in said housing with one end of said Bourdon being fixed and other end of said Bourdon tube being in contact with said valve arm,
whereby said dilution valve is operated when said Bourdon tube flexes due to changes in ambient pressure.

10. The apparatus in claim 9 where flexing of said Bourdon tube is restricted from movement by means at one or more positions along the length of said Bourdon tube thereby restricting the proportion to which said dilution valve is operated for a given ambient pressure,
whereby changes in ambient pressure causes said Bourdon tube to flex thereby operating said dilution valve and varying the flow of a gas through said dilution valve a predetermined amount for a given ambient pressure via said restriction by means of Bourdon tube movement.

11. The apparatus in claim 10 where said apparatus is for use with aircraft crew masks and said means to restrict flexing of said Bourdon tube are set screws, shims, or the shape of said housing, whereby the correct amount of added oxygen is supplied to aircrews over a wide range of ambient pressures.

12. The apparatus in claim 3 wherein said mechanical mechanism to transfer motion of said Bourdon tube to operate said dilution valve comprises:
(a) a gear train that operates said dilution valve,
(b) a linkage attaching said Bourdon tube to said gear train, and
(c) said Bourdon tube being positioned in said housing with one end of said Bourdon being secured to said housing and other end of said Bourdon tube being attached to said gear train via said linkage,
whereby said dilution valve is operated when said Bourdon tube flexes due to changes in ambient pressure.

13. The apparatus in claim 12 where flexing of said Bourdon tube is restricted from movement by means at one or more positions along the length of said Bourdon tube thereby restricting the proportion to which said dilution valve is operated for a given ambient pressure,
whereby changes in ambient pressure causes said Bourdon tube to flex thereby operating said dilution valve and varying the flow of a gas through said dilution valve a predetermined amount for a given ambient pressure via said restriction by means of Bourdon tube movement.

14. The apparatus in claim 13 where said apparatus is for use with aircraft crew masks and said means to restrict flexing of said Bourdon tube are set screws, shims, or the shape of said housing, whereby the correct amount of added oxygen is supplied to aircrews over a wide range of ambient pressures.

15. The apparatus in claim 3 wherein said mechanical mechanism to transfer motion of said Bourdon tube to operate said dilution valve comprises:
(a) a valve arm that operates said dilution valve,
(b) a belt,
(c) a spring,
(d) one end of said spring being fixed and the other end of said spring being attached to said valve arm,
(e) one end of said belt being attached to said valve arm, and
(f) said Bourdon tube being positioned in said housing with one end of said Bourdon being fixed and the other end of said Bourdon tube being attached to end of said belt opposite to said valve arm,
whereby said dilution valve is operated when said Bourdon tube flexes due to changes in ambient pressure.

16. The apparatus in claim 15 where flexing of said Bourdon tube is restricted from movement by means at one or more positions along the length of said Bourdon tube thereby restricting the proportion to which said dilution valve is operated for a given ambient pressure,
whereby changes in ambient pressure causes said Bourdon tube to flex thereby operating said dilution valve and varying the flow of a gas through said dilution valve a predetermined amount for a given ambient pressure via said restriction by means of Bourdon tube movement.

17. The apparatus in claim 16 where said apparatus is for use with aircraft crew masks and said means to restrict flexing of said Bourdon tube are set screws, shims, or the shape of said housing, whereby the correct amount of added oxygen is supplied to aircrews over a wide range of ambient pressures.

18. A method to dilute oxygen in a regulator in response to ambient pressure comprising the steps of:
(a) providing a Bourdon tube which flexes with changes in ambient pressure,
(b) providing a dilution valve which allows or restricts the flow of gas,
(c) operating said dilution valve with flexing motion of said Bourdon tube,
whereby changes in ambient pressure cause said Bourdon tube to flex which in turn operates said dilution valve thereby varying the flow rate of gas through said dilution valve based on ambient pressure.

19. The method of claim 18 where the flexing of said Bourdon tube is restricted from movement by means at one or more positions along curve of said Bourdon tube thereby restricting the proportion to which said dilution valve is operated for a given ambient pressure,
whereby changes in ambient pressure causes said Bourdon tube to flex thereby operating said dilution valve and varying the flow of a gas through said dilution valve a predetermined amount for a given ambient pressure via said restriction by means of Bourdon tube movement.

20. The method of claim 19 where said method is used on aircraft crew masks, whereby the correct amount of added oxygen is supplied to aircrews over a wide range of ambient pressures.
